(19) United States
(12) Patent Application Publication
(10) Pub. No.: US 2025/0206274 A1
(43) Pub. Date: Jun. 26, 2025

(54) BRAKE SYSTEM

(71) Applicant: TOYOTA JIDOSHA KABUSHIKI KAISHA, Aichi-ken (JP)

(72) Inventor: Shinsuke YAMAMOTO, Anjyo-shi (JP)

(21) Appl. No.: 18/979,609

(22) Filed: Dec. 13, 2024

(30) Foreign Application Priority Data
Dec. 20, 2023 (JP) 2023-214489

(51) Int. Cl. B60T 8/172; B60T 8/171; B60T 13/74

(52) U.S. Cl. CPC B60T 8/172; B60T 8/171; B60T 13/746

(57) ABSTRACT

A brake system having a brake control portion configured to control an electronic parking brake, wherein the brake control portion includes a release control portion configured to execute a release control in different modes based on a brake temperature that is a temperature of the electronic parking brake, the release control being for releasing the electronic parking brake.

### REFERENCE TO RELATED APPLICATION

This application claims priority from Japanese Patent Application No. 2023-214489 filed on Dec. 20, 2023. The entire content of the priority application is incorporated herein by reference.

### TECHNICAL FIELD

The following disclosure relates to a brake system including a parking brake.

### BACKGROUND

Japanese Patent Application Publication No. 2009-149256 (JP 2009-149256A) describes a disc brake in which a friction engagement member is shared by a parking brake and a service brake. In this disc brake, when a brake temperature decreases in an operating state of the parking brake, a pressing force for pressing the friction engagement member against a brake rotor is added. Accordingly, it is possible to suppress a decrease in the pressing force due to the temperature decrease in the operating state of the parking brake.

### SUMMARY

An object of the present disclosure is to suppress noise generated in an electric actuator while suppressing dragging in an electronic parking brake operated by the electric actuator.

In the present brake system, a release control is executed by an operation of the electric actuator when the electronic parking brake is released. This release control is executed in different modes based on the brake temperature.

For example, a case in which a first release control and a second release control are executed as the release control is considered. The first release control is a control in which a drive member is retracted or moved backward by the operation of the electric actuator until the pressing force in the electronic parking brake becomes smaller than a set value. The second release control is a control for further retracting the drive member by the operation of the electric actuator after the pressing force in the electronic parking brake becomes smaller than the set value. When the vehicle travels after the electronic parking brake is released and a service brake is operated, a brake temperature, which is a temperature of the electronic parking brake, increases. If the brake temperature increases, the friction engagement member may thermally expand, and dragging may be caused. In order to avoid this, the second release control is executed to retract the drive member beforehand.

A release control amount of the drive member in the first release control is larger when the brake temperature at the time of release of the electronic parking brake is high than when the brake temperature is low. This is because the friction engagement member thermally expands more when the brake temperature is high than when the brake temperature is low. The release control amount refers to a retracting amount by which the drive member is retracted in the release control. The release control amount of the drive member in the second release control is preferably larger when the brake temperature is low than when the brake temperature is high. This is because when the brake temperature at the time of release of the electronic parking brake is low, the brake temperature is likely to increase due to the operation of the service brake during traveling, the friction engagement member is likely to thermally expand, and the dragging is likely to be caused.

As described above, the release control of the electronic parking brake is executed in different modes based on the brake temperature, so that the release control amount of the drive member after the pressing force becomes smaller than the set value can be determined to have an appropriate magnitude while suppressing the dragging. Thus, this configuration suppresses un unnecessary operation of the electric actuator and enables an appropriate length of the operation time. It is possible to suppress operation noise generated in the electric actuator and reduce power consumption.

### BRIEF DESCRIPTION OF DRAWINGS

The objects, features, advantages, and technical and industrial significance of the present disclosure will be better understood by reading the following detailed description of an embodiment, when considered in connection with the accompanying drawings, in which:

FIG. 1 is a view conceptually showing a part of a brake system according to an embodiment of the present disclosure;

FIG. 2 is a flowchart showing a first release control and second release control program stored in a storage portion of a brake ECU of the brake system;

FIG. 3 is a flowchart showing a part (the second release control) of the program;

FIG. 4 is a flowchart showing a third release control program stored in the storage portion;

FIG. 5 is a time chart showing an operation of the brake system in a cold temperature condition;

FIG. 6 is a time chart showing an operation of the brake system in a normal temperature condition; and

FIG. 7 is a time chart showing an operation of the brake system in a high temperature condition.

### DESCRIPTION

Referring to the drawings, there will be hereinafter described in detail a brake system according to an embodiment of the present disclosure.

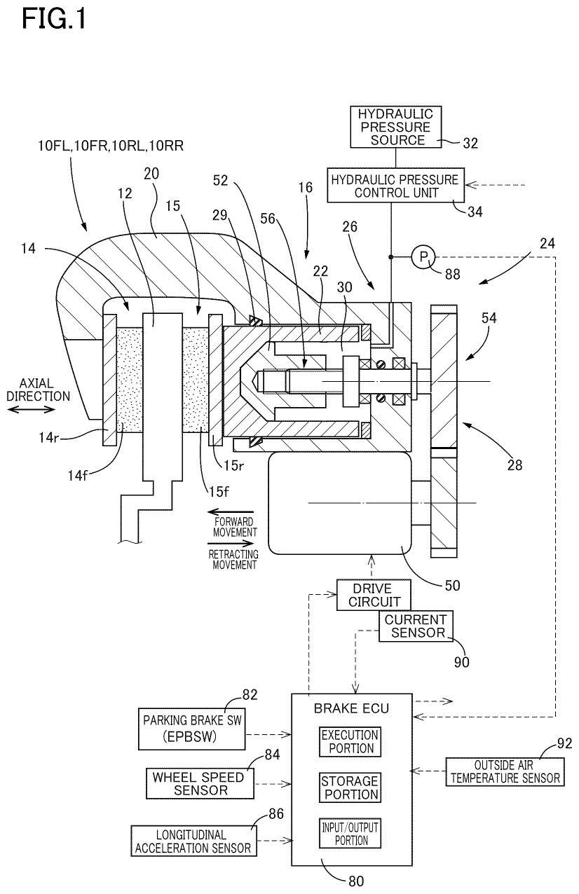

As shown in FIG. 1, the brake system according to the present embodiment is provided in a vehicle and includes disc brakes 10FL, 10FR, 10RL, 10RR, and the like. The disc brakes 10FL, 10FR, 10RL, 10RR are provided respectively for a front left wheel, a front right wheel, a rear left wheel, and a rear right wheel of the vehicle. Hereinafter, the suffixes FL, FR, RL, RR each indicating a wheel position will be omitted when it is not necessary to distinguish the disk brakes and the like by the wheel positions or when the disk brakes and the like are collectively referred to. The disc brake 10 can operate as a service brake and as a parking brake.

The disc brake 10 is configured such that a pair of friction pads 14, 15 are pressed against a brake rotor 12 to frictionally engage the friction pads 14, 15 and the brake rotor 12 with each other, thereby suppressing rotation of the wheel. The disc brake 10 includes, for example, the pair of friction pads 14, 15 and a pressing device 16. The brake rotor 12 is rotatable integrally with the wheel. The friction pads 14, 15 are disposed on both sides of the brake rotor 12. The friction pad 14 includes a friction engagement member 14f and a back plate 14r. The friction pad 15 includes a friction engagement member 15f and a back plate 15r. The pressing device 16 includes, for example, a caliper 20, a piston 22, and a drive device 24. In the present embodiment, the drive device 24 includes a hydraulic pressure drive device 26 and an electric drive device 28. The friction pads 14, 15 are shared by the service brake and the parking brake.

The caliper 20 is held by a non-rotating member so as to be movable in a direction parallel to a rotation axis of the wheel. The piston 22 is held in a cylinder bore provided in the caliper 20 such that the piston 22 is unrotatable and movable relative to the caliper 20. The piston 22 is one example of a pressing member. A piston seal 29 is provided on an outer circumferential portion of the piston 22. The cylinder bore of the caliper 20 defines a hydraulic pressure chamber 30 behind the piston 22.

The hydraulic pressure drive device 26 includes, for example, the hydraulic pressure chamber 30, a hydraulic pressure source 32, and a hydraulic pressure control unit 34. The hydraulic pressure source 32 is connected to the hydraulic pressure chamber 30 via the hydraulic pressure control unit 34. The hydraulic pressure source 32 includes at least one of a manual hydraulic pressure source and a power hydraulic pressure source. The manual hydraulic pressure source generates a hydraulic pressure by an operation of a brake operation member by a driver of the vehicle. The power hydraulic pressure source can generate a hydraulic pressure by driving a pump or the like even if the brake operation member is not operated. For example, the hydraulic pressure control unit 34 may include one or more electromagnetic valves or the like. The hydraulic pressure of the hydraulic pressure source 32 is controlled by the hydraulic pressure control unit 34 and is supplied to the hydraulic pressure chamber 30. The piston 22 is moved forward by the hydraulic pressure in the hydraulic pressure chamber 30 so that the service brake is operated.

The electric drive device 28 includes, for example, an electric actuator 50, a nut member 52, a rotation transmission device 54, and a motion conversion device 56. The electric actuator 50 includes an electric motor. The nut member 52 is one example of a drive member. The nut member 52 is provided inside the piston 22 so as to be movable and unrotatable relative to the piston 22. The rotation transmission device 54 transmits rotation of the electric actuator 50 to the motion conversion device 56, for example. The rotation transmission device 54 may include a plurality of gears. The motion conversion device 56 may include, for example, a screw mechanism. The motion conversion device 56 converts a rotational motion of the electric actuator 50 into a linear motion to linearly move the nut member 52. When the nut member 52 is linearly moved by the electric actuator 50, the piston 22 is moved forward to operate the parking brake. Thus, the parking brake may be referred to as an electronic parking brake.

The screw mechanism of the motion conversion device 56 makes it difficult for the electric actuator 50 to be rotated by an external force in the operating state of the parking brake. Therefore, in the operating state of the parking brake, a pressing force is maintained even if electric power is not supplied to the electric actuator 50.

In the present embodiment, the service brake and the parking brake are driven by different drive devices.

The brake system includes a brake electronic control unit (ECU) 80 mainly constituted by a computer. The hydraulic pressure control unit 34, the electric actuator 50, and the like are connected to the brake ECU 80. Further, an electronic parking brake switch (EPBSW) 82, wheel speed sensors 84, a longitudinal acceleration sensor 86, a hydraulic pressure sensor 88, a current sensor 90, an outside air temperature sensor 92, and the like are connected to the brake ECU 80. The EPBSW 82 is manually operable. An operation instruction is issued by an operation of the EPBSW 82 in a non-operating state of the parking brake, and a release instruction is issued by an operation of the EPBSW 82 in the operating state of the parking brake. The wheel speed sensors 84 are respectively provided for the front right and left wheels and the rear right and left wheels. Each wheel speed sensor 84 detects a rotational speed of a corresponding one of the wheels. The longitudinal acceleration sensor 86 detects longitudinal acceleration of the vehicle. The hydraulic pressure sensor 88 detects the hydraulic pressure in the hydraulic pressure chamber 30 of each disc brake 10. The current sensor 90 detects a current flowing through the electric actuator 50 of each disc brake 10. The outside air temperature sensor 92 detects a temperature of the atmosphere around the vehicle.

In the brake system configured as described above, when the hydraulic pressure is supplied to the hydraulic pressure chamber 30, the piston 22 is moved forward, and the friction pad 15 is pressed against the brake rotor 12. The caliper 20 is moved, and the friction pad 14 is pressed against the brake rotor 12 by the caliper 20. The pair of friction pads 14, 15 are pressed against the brake rotor 12 to operate the service brake. When the hydraulic pressure in the hydraulic pressure chamber 30 is released, the piston 22 is retracted by a restoring force of the piston seal 29. The piston 22 may be retracted by vibration or the like of the brake rotor 12 during traveling of the vehicle.

When the EPBSW 82 is operated in a state in which the service brake is in the operating state and the vehicle is stopped, the parking brake is operated by the operation of the electric actuator 50. The nut member 52 is moved forward and comes into contact with the inner surface of the piston 22. The forward movement of the piston 22 causes the friction pads 14, 15 to be further pressed against the brake rotor 12. As a result, the parking brake is operated. When the EPBSW 82 is operated in the operating state of the parking brake, the nut member 52 is retracted by the operation of the electric actuator 50. The piston 22 is returned by the piston seal 29. The nut member 52 is retracted relative to the piston 22. The nut member 52 is further retracted after the pressing force of the parking brake becomes smaller than a set value.

In the present description, the pressing force when the pair of friction pads 14, 15 are pressed against the brake rotor 12 in the disc brake 10 may be simply referred to as a pressing force, a pressing force of the disc brake, a pressing force of the parking brake, a pressing force of the service brake, or the like.

Further, in the disc brake, the limit of the retracting movement of the piston 22 is determined by the nut member 52. As described above, the piston 22 may be retracted by the vibration of the brake rotor 12. However, the piston 22 can be retracted until it comes into contact with the nut member 52.

In a conventional brake system, a first release control and a second release control are executed as a release control that is a control for releasing the parking brake. The first release control is a control for retracting the nut member 52 until the pressing force becomes smaller than the set value. The second release control is a control for retracting the nut member 52 by a predetermined set release control amount after the pressing force becomes smaller than the set value. The second release control is executed to suppress the dragging during traveling of the vehicle. In a case where the temperature of the friction pads 14, 15 is substantially equal to the outside air temperature at the time of release of the parking brake, for example, the friction pads 14, 15 thermally expand greatly if the temperature of the friction pads 14, 15 increases due to the operation of the service brake during traveling after the parking brake is released. In a case where the set release control amount is small in this instance, the retracting movement of the piston 22 is limited by the nut member 52 and the dragging may be caused even if a force in the backward direction acts on the piston 22 due to the vibration of the brake rotor 12.

Therefore, the set release control amount is set to a large value in the conventional brake system. As described above, the set release control amount is a value determined based on the thermal expansion amount of the friction pads 14, 15 and the like in a case where it is assumed that the temperature of the friction pads 14, 15 becomes high due to the operation of the service brake during traveling when the temperature of the friction pads 14, 15 at the time of release of the parking brake is the outside air temperature. The nut member 52 is retracted by the set release control amount regardless of whether the temperature of the friction pads 14, 15 at the time of release of the parking brake is high or low.

Hereinafter, the temperature of the friction pads 14, 15 (the friction engagement members 14f, 15f) of the disc brake 10 is referred to as a brake temperature. In the present embodiment, the brake temperature is classified into a high temperature, a normal temperature, and a cold temperature. The high temperature is a temperature at which the friction engagement members 14f, 15f are abnormally overheated. The high temperature may be, for example, a temperature of 300° C. or higher. The normal temperature is a temperature of the friction engagement members 14f, 15f during a normal operation of the service brake. The normal temperature may be, for example, a temperature lower than 300° C. and equal to or higher than 100° C. The cold temperature may be a temperature around the outside air temperature. For example, the cold temperature may be a temperature lower than 100° C.

The brake temperature can be estimated based on, for example, the temperature of the friction pads 14, 15 in the operating state of the service brake, the operating time of the parking brake, the outside air temperature when the EPBSW 82 is operated.

For example, when the operating time of the parking brake is shorter than a first set time which is a set time, it can be estimated that the brake temperature at the time of release of the parking brake is a temperature belonging to the same classification as the brake temperature in the operating state of the service brake. When the operating time of the parking brake is longer than a second set time which is the set time, it can be estimated that the brake temperature at the time of release of the parking brake is the cold temperature.

When the operating time of the parking brake is equal to or longer than the first set time and equal to or shorter than the second set time, it can be estimated that the brake temperature at the time of release of the parking brake is a temperature affected by the brake temperature in the operating state of the service brake. For example, when the brake temperature in the operating state of the service brake is the high temperature, it can be estimated that the brake temperature at the time of release of the parking brake is the normal temperature. When the brake temperature in the operating state of the service brake is the normal temperature, it can be estimated that the brake temperature at the time of release of the parking brake is the cold temperature.

The brake temperature in the operating state of the service brake can be estimated based on the rotational speed of the wheel, the longitudinal acceleration, the hydraulic pressure, and the like. For example, when the wheel speed is high, the frictional heat is more likely to be high than when the wheel speed is low. Therefore, it is estimated that the brake temperature is high. When the hydraulic pressure is high, the pressing force is larger and the frictional force is larger than those when the hydraulic pressure is low. Therefore, it is estimated that the brake temperature is high. When deceleration, which is the longitudinal acceleration, is large, the braking force can be estimated to be larger than when the deceleration is small. Therefore, it is estimated that the brake temperature is high.

Further, when the service brake is operated in a state in which the vehicle is traveling under a high load, it can be estimated that the brake temperature is the high temperature. The high-load traveling is traveling in which a high load is applied to the service brake and includes traveling on a long downhill, high-speed traveling on a road with many curves (referred to as circuit traveling), and the like.

When the service brake is operated in a state in which the vehicle normally travels, the brake temperature can be estimated to be the normal temperature.

The timing of release of the parking brake refers to at least one period from the start to the end of the release control. It can be estimated that the brake temperature is substantially constant while the release control is executed. Further, the timing of release of the parking brake may be timing when the EPBSW 82 is operated in the operating state of the service brake.

On the other hand, when a release control amount of the nut member 52 in the second release control is large, the operation time of the electric actuator 50 becomes long. The release control amount refers to a retracting amount of the nut member 52 in the release control. Further, when the release control amount is large, a lock control amount, which is a forward movement amount of the nut member 52 when the parking brake is locked, also becomes large, and the operation time of the electric actuator 50 becomes long. Since sound is generated when the electric actuator 50 is operated, this causes such a problem that the sound is annoying. Therefore, it is desirable to set the operation time of the electric actuator 50 to an appropriate length.

As described above, in the conventional brake system, it is assumed that the brake temperature when the parking brake is released is the cold temperature. However, the brake temperature when the parking brake is released is not necessarily the cold temperature. For example, a case is conceivable in which the parking brake is operated in a state in which the brake temperature in the operating state of the service brake is the high temperature and the parking brake is released before the first set time elapses. In this case, the brake temperature when the parking brake is released is estimated to be the high temperature. Therefore, the release control amount of the nut member 52 in the first release control increases. On the other hand, it is considered that the brake temperature is less likely to become higher than the brake temperature at the time of release of the parking brake due to the operation of the service brake during traveling of the vehicle after the release of the parking brake. It is thus considered that the dragging is unlikely to be caused even if the release control amount in the second release control is small.

From the above circumstances, when the brake temperature at the time of release of the parking brake is high, it is considered that the necessity of setting the release control amount in the second release control to a large value is low. In the present embodiment, therefore, the second release control is executed in different modes based on the brake temperature at the time of release of the parking brake. Specifically, the release control amount of the nut member in the second release control is determined based on the brake temperature.

Further, in the conventional brake system, it is assumed that the brake temperature becomes the high temperature due to the operation of the service brake during traveling after the release of the parking brake. However, there may be a case where the brake temperature does not become the high temperature due to the operation of the service brake during traveling. For example, when the service brake is operated during traveling in the normal state, the brake temperature is estimated to be the normal temperature. Further, in a case where the brake system is mounted on a front-wheel drive hybrid vehicle or a vehicle in which a front-rear braking force distribution control is executed, the pressing force of the disc brake 10 is usually smaller in the rear wheel than in the front wheel. Therefore, in the disc brake 10 of the rear wheel, the brake temperature is less likely to become the high temperature during traveling.

In view of the above circumstances, in the present embodiment, the release control amount of the nut member 52 in the second release control is set to a value smaller than the conventional set release control amount. In addition, when the brake temperature becomes high during traveling after the parking brake is released, the nut member 52 is retracted. The release control of the nut member 52 is referred to as a third release control.

In the present embodiment, the brake temperature is acquired when the EPBSW 82 is operated in the operating state of the service brake (which is one example of the timing of release of the parking brake).

In the present embodiment, the release control for the parking brake includes the first release control, the second release control, the third release control, and the like, as described above. When the conventional brake system and the brake system according to the present embodiment are compared, the first release control is the same, but the second release control is different. In the conventional brake system, the second release control is executed in the same mode regardless of whether the brake temperature at the time of release of the parking brake is high or low. In contrast, in the present embodiment, the second release control is executed in different modes based on the brake temperature at the time of release of the parking brake. In the conventional brake system, the third release control is not executed. However, in the present embodiment, the third release control is executed when the brake temperature becomes the high temperature during traveling. In other words, in the conventional brake system, the third release control is a part of the second release control. However, in the present embodiment, the third release control is separated from the second release control and is executed when the brake temperature becomes the high temperature during traveling.

In the first release control, for example, when a condition that a current flowing through the electric actuator 50 is smaller than a set current and a state in which a change in the current is small continues for a set time or more is satisfied, it can be acquired that the pressing force is smaller than the set value. The state in which the pressing force is smaller than the set value may be estimated as a state in which the pressing force is substantially zero. In the first release control, the release control amount of the nut member 52 is larger when the brake temperature is high than when the brake temperature is low. This is because the friction pads 14, 15 are greatly thermally expanded.

In the second release control, when the brake temperature is the high temperature or the normal temperature, the release control amount is made smaller than when the brake temperature is the cold temperature. This is because, when the brake temperature at the time of release of the parking brake is the high temperature or the normal temperature, there is a low possibility that the dragging is caused by the brake temperature that becomes higher than the brake temperature at the time of release of the parking brake due to the operation of the service brake during traveling. On the other hand, when the brake temperature at the time of release of the parking brake is the cold temperature, there is a possibility that the dragging is caused due to a shortage of the release control amount of the nut member 52 when the brake temperature rises to the normal temperature by the operation of the service brake during traveling.

In the present embodiment, a target release control amount in the second release control in a case where the brake temperature at the time of release of the parking brake is the cold temperature is referred to as a cold-temperature-condition release control amount. Further, a target release control amount in the second release control in a case where the brake temperature at the time of release of the parking brake is the normal temperature is referred to as a normal-temperature-condition release control amount. Further, a target release control amount in the second release control in a case where the brake temperature at the time of release of the parking brake is the high temperature is referred to as a high-temperature-condition release control amount. The high-temperature-condition release control amount and the normal-temperature-condition release control amount are smaller than the cold-temperature-condition release control amount.

For example, the high-temperature-condition release control amount and the normal-temperature-condition release control amount are determined to be a value ΔRb at which the dragging is unlikely to be caused even if the brake temperature rises due to a plurality of operations of the service brake during traveling. For example, ΔRb may be determined based on a thermal expansion amount of the friction pads 14, 15 based on a temperature rise caused by operating the service brake a plurality of times during traveling, an uneven wear amount of the friction pads 14, 15, the brake rotor 12, and the like, a margin value, and the like.

For example, the cold-temperature-condition release control amount is determined to be a value (ΔRa+ΔRb) obtained by adding the above-described ΔRb to a value ΔRa at which the dragging is considered to be unlikely to be caused even if the brake temperature increases to the normal temperature during traveling. ΔRa may be determined based on, for example, the thermal expansion amount of the friction pads 14, 15 due to an increase in the temperature of the friction pads 14, 15 from the cold temperature to the normal temperature.

As described above, at the start of the second release control, the target release control amount is determined based on the brake temperature, and the electric actuator 50 is operated until the actual release amount of the nut member 52 reaches the target release control amount.

The target release control amount in the third release control may be, for example, a value ΔRc based on the thermal expansion amount of the friction pads in a case where the brake temperature increases from the normal temperature to the high temperature. After the second release control ends in the parking brake, the brake temperature becomes the high temperature when the vehicle performs high-load traveling, for example. On the other hand, when the brake temperature at the time of release of the parking brake is the cold temperature or the normal temperature, the nut member 52 is retracted in the second release control without considering the thermal expansion amount when the brake temperature becomes the high temperature. Therefore, when the brake temperature becomes the high temperature and the friction pads 14, 15 thermally expand after the end of the second release control, the dragging may be caused. Therefore, when the brake temperature becomes the high temperature after the end of the second release control, the nut member 52 is further retracted.

In the present embodiment, the actual retracting amount of the nut member 52 in the second release control and the third release control is acquired based on the operation time of the electric actuator 50. Since the load applied to the nut member 52 is very small after the pressing force becomes smaller than the set value, the retracting speed of the nut member 52 can be estimated based on the rotational speed of the electric actuator 50. Thus, it can be considered that the nut member 52 is retracted by the target release control amount when a target release control time corresponding to the target release control amount is acquired and the actual operation time of the electric actuator 50 in the second release control reaches a target release time.

Each of the values ΔRa, ΔRb, and ΔRc described above may be a set value set in advance. The values ΔRa, ΔRb, and ΔRc may be the same regardless of whether the brake temperature is the high temperature, the normal temperature, or the cold temperature.

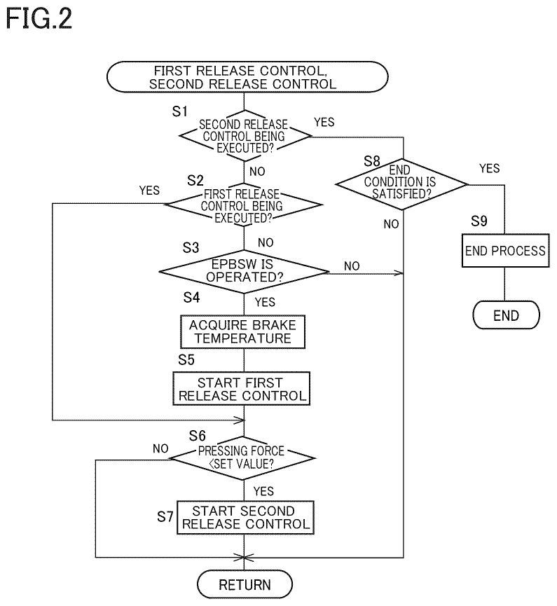

A first release control and second release control program shown in the flowchart of FIG. 2 is executed every predetermined set time. In Step 1, it is determined whether or not the second release control is being executed. (Hereinafter, Step 1 will be abbreviated as S1. Other steps will be similarly abbreviated.) In S2, it is determined whether or not the first release control is being executed. In S3, it is determined whether or not the EPBSW 82 is operated in the operating state of the service brake. When the determinations in S1-S3 are NO, S1, S2, and S3 are repeatedly executed. If the determination in S3 is YES, the brake temperature is acquired in S4, and the first release control is started in S5. Then, it is determined in S6 whether or not the pressing force is smaller than the set value. When the determination in S6 is NO, the first release control is continuously executed. The determination in S2 is YES, and S6 is executed. When the determination in S6 is YES, the second release control is started in S7.

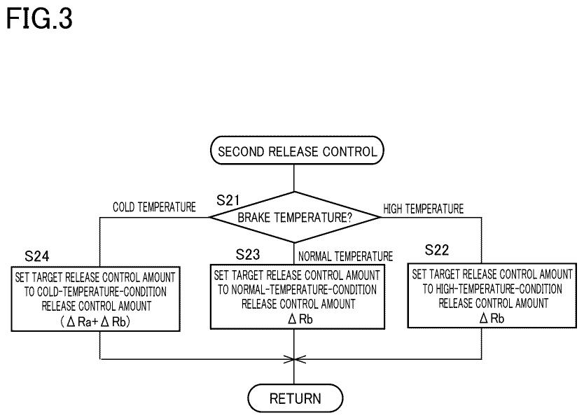

The second release control is represented by the flowchart of FIG. 3. In S21, it is determined whether the brake temperature acquired in S4 is the high temperature, the normal temperature, or the cold temperature. When the temperature is the high temperature, the target release control amount is determined to be the high-temperature-condition release control amount ΔRb in S22. When the brake temperature is the normal temperature, the target release control amount is determined to be the normal-temperature-condition release control amount ΔRb in S23. When the brake temperature is the cold temperature, the target release control amount is determined to be the cold-temperature-condition release control amount (ΔRa+ΔRb) in S24. Then, the electric actuator 50 is operated such that the actual release control amount of the nut member 52 reaches the target release control amount.

When the second release control is being executed, the determination in S1 is YES. It is thus determined in S8 whether or not an end condition of the second release control is satisfied. It is determined whether or not the release control amount of the nut member 52 has reached the target release control amount. Specifically, it is determined whether or not the actual operation time of the electric actuator 50 in the second release control has reached a target control time corresponding to the target release control amount. When the determination in S8 is NO, the second release control is continuously executed. When the determination in S8 is YES, on the other hand, an end process is executed in S9.

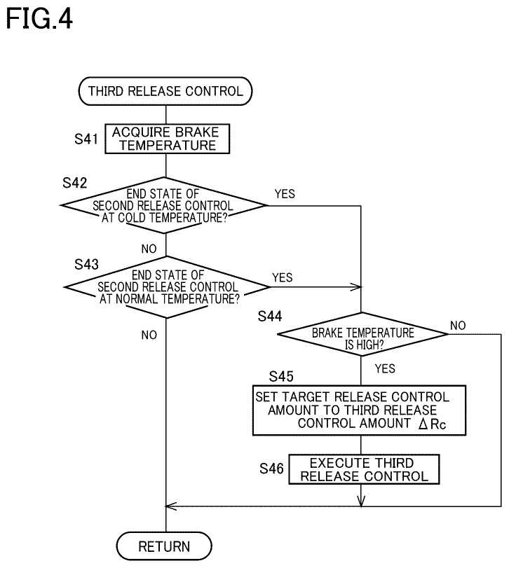

Thereafter, the vehicle usually starts traveling. While the vehicle is traveling, the brake temperature may rise due to the operation of the service brake. While the vehicle is traveling, a third release control program represented by the flowchart of FIG. 4 is executed every predetermined set time. In S41, the brake temperature is acquired. In S42 and S43, it is determined whether the second release control is executed at the cold temperature or the normal temperature. In other words, it is determined whether the brake temperature at the time of release of the parking brake is the cold temperature or the normal temperature. When the determination in S42 or S43 is YES, it is determined in S44 whether or not the brake temperature is the high temperature. When the determination is YES, the target release control amount is determined to be ΔRc in S45. In S46, the nut member 52 is retracted until the release control amount of the nut member 52 reaches the target release control amount.

It is noted that the third release control may be executed only once or may be executed a plurality of times each time the brake temperature becomes the high temperature, after the end of the second release control and before the parking brake is operated next time. When the third release control is executed a plurality of times, the target release control amount ΔRc may be set to a smaller value than when the third release control is executed only once.

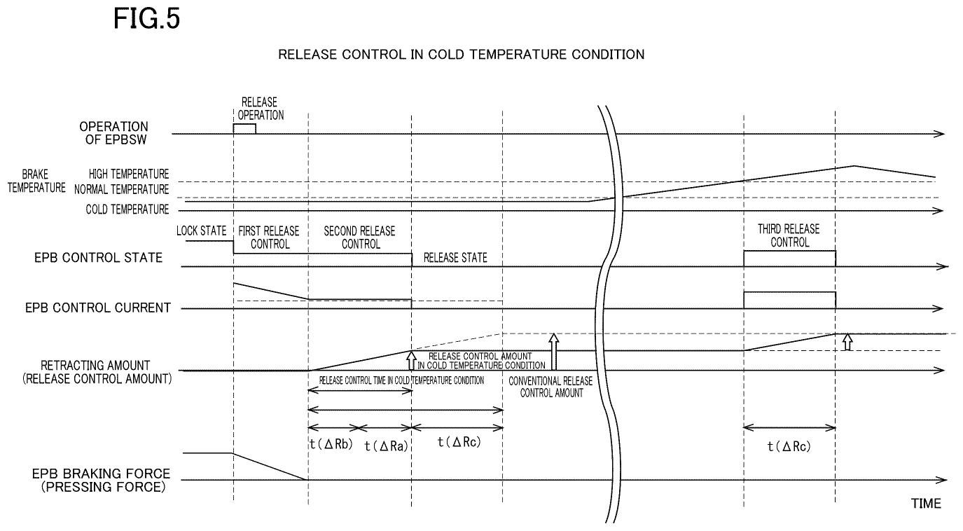

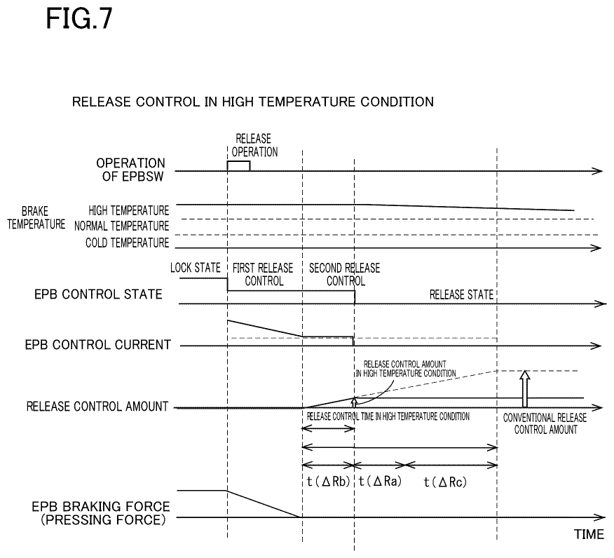

FIGS. 5, 6, and 7 show changes in the current, the release control amount of the nut member 52, the brake temperature, and the like over time when the release control of the parking brake is executed as described above. As indicated by broken lines in FIGS. 5, 6, and 7, in the conventional brake system, the target release control amount in the second release control is set to ΔRa+ΔRb+ΔRc regardless of whether the brake temperature is high or low. In contrast, in the present embodiment, the second release control is executed in different modes based on the brake temperature. Specifically, in the second release control, the target release control amount is set to (ΔRa+ΔRb) when the brake temperature is the cold temperature, and is set to ΔRb when the brake temperature is equal to or higher than the normal temperature. Therefore, a clearance can be maintained at an appropriate size, and the dragging can be favorably suppressed. In addition, an unnecessary operation of the electric actuator 50 can be suppressed, and the operation time can be determined to be an appropriate length.

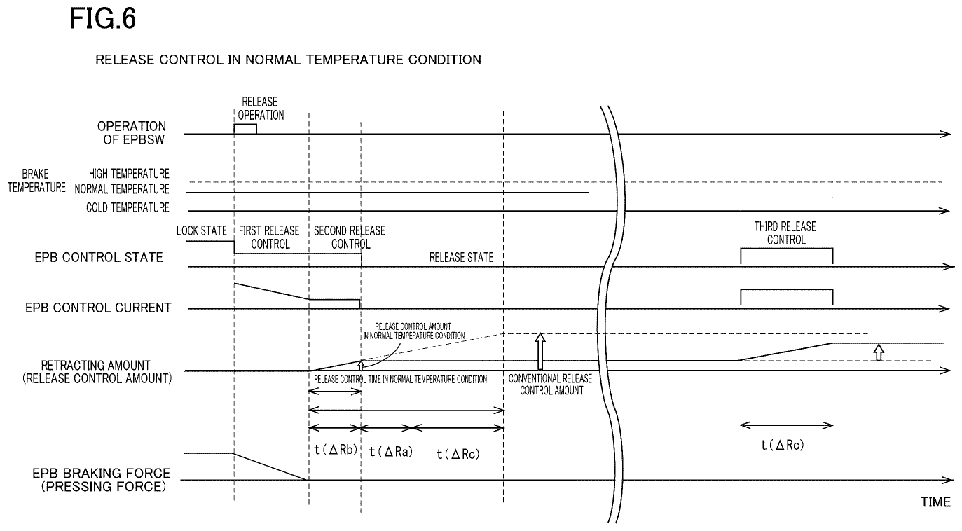

On the other hand, in a case where the second release control is executed at the cold temperature as shown in FIG. 5 and in a case where the second release control is executed at the normal temperature as shown in FIG. 6, the third release control is executed when the brake temperature becomes the high temperature during traveling, so that the nut member 52 is retracted by the target release control amount ΔRc. As a result, it is possible to satisfactorily suppress the dragging caused by the shortage of the release control amount of the nut member 52 in the second release control. In addition, since the nut member 52 is retracted as necessary while the vehicle is traveling after the end of the second release control, the target release control amount in the second release control can be set to a small value. Thus, an unnecessary operation of the electric actuator 50 can be further suppressed. It is possible to suppress the sound generated in association with the operation of the electric actuator 50 and to reduce power consumption.

In the above embodiment, the third release control is executed when the brake temperature becomes the high temperature after the end of the second release control. However, the third release control may be executed when the brake temperature is estimated to become the high temperature. For example, the third release control may be started when the vehicle is traveling under a high load.

In the above embodiment, the brake ECU 80 and the like constitute a brake control portion, and a portion of the brake control portion that stores S1-S9, S21-S24, and S41-S46, a portion of the brake control portion that executes S1-S9, S21-S24, and S41-S46, and the like constitute a release control portion.

The present disclosure may be embodied in other various forms with various modifications and improvements based on the knowledge of those skilled in the art.

### Claimable Invention

(1) A brake system having a brake control portion configured to control an electronic parking brake, wherein the brake control portion includes a release control portion configured to execute a release control in different modes based on a brake temperature that is a temperature of the electronic parking brake, the release control being for releasing the electronic parking brake.

(2) The brake system according to the form (1), wherein the electronic parking brake is configured such that a drive member presses a friction engagement member against a brake rotor, wherein the release control includes a first release control for retracting the drive member until a pressing force of the electronic parking brake becomes smaller than a set value and a second release control for further retracting the drive member after the pressing force becomes smaller than the set value, and wherein the release control portion includes a portion that determines, based on the brake temperature, a release control amount that is a retracting amount of the drive member in the second release control.

(3) The brake system according to the form (2), wherein the release control portion includes a portion that determines the release control amount in the second release control to be a smaller value when the brake temperature is high than when the brake temperature is low.

(4) The brake system according to the form (3), wherein the release control portion includes a portion that determines the release control amount in the second release control based on a degree of thermal expansion of the friction engagement member during traveling of the vehicle after the parking brake is released.

(5) The brake system according to any one of the forms (2)-(4), wherein the release control further includes a third release control in which the drive member is further retracted after the second release control ends, and wherein the release control portion executes the third release control when the brake temperature becomes equal to or higher than a set temperature after the end of the second release control or when the brake temperature is estimated to become equal to or higher than the set temperature after the end of the second release control, and the release control portion does not execute the third release control when the brake temperature is lower than the set temperature or when the brake temperature is not estimated to become equal to or higher than the set temperature.

The set temperature may be, for example, a temperature determined based on the temperature of the friction engagement member when the service brake is operated during high-load traveling. For example, the set temperature may be about 300° C.

(6) The brake system according to any one of the above forms (2)-(5), wherein the release control includes a third release control in which the drive member is further retracted after the second release control ends, and wherein the release control portion executes the third release control when the brake temperature at the start of the release control is lower than the set temperature and the brake temperature becomes equal to or higher than the set temperature after the end of the second release control, and the release control portion does not execute the third release control when the brake temperature at the start of the release control is equal to or higher than the set temperature or when the brake temperature does not become equal to or higher than the set temperature after the end of the second release control.

(7) The brake system according to any one of the above forms (1)-(6), wherein the electronic parking brake includes a friction engagement member and a pressing device configured to press the friction engagement member against a brake rotor, and wherein the friction engagement member of the electronic parking brake is shared with a service brake.

In the electronic parking brake, the friction engagement member is pressed against the brake rotor by a forward movement of the drive member by the electric actuator.

(8) The brake system according to the form (7), wherein the pressing device includes an electric actuator that moves a drive member to press the friction engagement member against the brake rotor, and wherein the service brake includes a pressing device including a piston configured to press the friction engagement member against the brake rotor and a hydraulic pressure source configured to apply a hydraulic pressure to the piston.

What is claimed is:

1. A brake system having a brake control portion configured to control an electronic parking brake,
wherein the brake control portion includes a release control portion configured to execute a release control in different modes based on a brake temperature that is a temperature of the electronic parking brake, the release control being for releasing the electronic parking brake.

2. The brake system according to claim 1,
wherein the electronic parking brake is configured such that a drive member presses a friction engagement member against a brake rotor,
wherein the release control includes a first release control for retracting the drive member until a pressing force of the electronic parking brake becomes smaller than a set value and a second release control for further retracting the drive member after the pressing force becomes smaller than the set value, and
wherein the release control portion includes a portion that determines, based on the brake temperature, a release control amount that is a retracting amount of the drive member in the second release control.

3. The brake system according to claim 2, wherein the release control portion includes a portion that determines the release control amount in the second release control to be a smaller value when the brake temperature is high than when the brake temperature is low.

4. The brake system according to claim 2,
wherein the release control further includes a third release control in which the drive member is further retracted after the second release control ends, and
wherein the release control portion executes the third release control when the brake temperature becomes equal to or higher than a set temperature after an end of the second release control or when the brake temperature is estimated to become equal to or higher than the set temperature after the end of the second release control, and the release control portion does not execute the third release control when the brake temperature is lower than the set temperature or when the brake temperature is not estimated to become equal to or higher than the set temperature.

5. The brake system according to claim 1,
wherein the electronic parking brake includes a friction engagement member and a pressing device configured to press the friction engagement member against a brake rotor, and
wherein the friction engagement member of the electronic parking brake is shared with a service brake.
